(19) United States
(12) Patent Application Publication
(10) Pub. No.: US 2009/0138969 A1
(43) Pub. Date: May 28, 2009

(54) DEVICE AND METHOD FOR BLOCKING AUTORUN OF MALICIOUS CODE

(76) Inventors: Yun Ju Kim, Gyeonggi-do (KR); Young Tae Yun, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/209,361

(22) Filed: Sep. 12, 2008

(30) Foreign Application Priority Data
Nov. 26, 2007 (KR) 10-2007-0120600
Mar. 25, 2008 (KR) 10-2008-0027301

(51) Int. Cl. G06F 21/06

(52) U.S. Cl. 726/22

(57) ABSTRACT

A device and method for blocking autorun of a malicious code through an autorun file stored in a removable storage device are provided. A device manager monitors a connection of a removable storage device, acquires a global unique identifier of the removable storage device, and deletes an autorun file for running the malicious code from the removable storage. A registry manager determines whether a registry key for storing content of the autorun file is generated using the global unique identifier of the removable storage device and deletes the registry key. The present invention can block autorun of a malicious code stored in the removable storage device by retrieving and deleting a registry key for performing the autorun technique when a removable storage device is connected to a system.

### CROSS-REFERENCE TO RELATED APPLICATION

This application claims priority to and the benefit of Korean Patent Application No. 2007-120600, filed Nov. 26, 2007, and No. 2008-27301, filed Mar. 25, 2008, the disclosure of which is incorporated herein by reference in its entirety.

### BACKGROUND

1. Field of the Invention

The present invention relates to a device and method for blocking autorun of a malicious code, and more particularly, to a device and method for blocking autorun of a malicious code through an autorun file stored in a removable storage.

2. Discussion of Related Art

Malicious code infection attacks through removable storage devices such as a universal serial bus (USB) memory using a Windows autorun technique are increasing. The Windows autorun technique is a technique for automatically running a specific command according to content of an autorun file (autorun.inf) stored in the removable storage device when the removable storage device is connected to a Windows operating system (OS) via a USB port or the like.

FIG. 1 shows a malicious code infection process using the autorun technique.

Referring to FIG. 1, a malicious user such as a hacker stores a malicious code 121 and an autorun.inf file 122 for automatically running the malicious code in a removable storage device 110 such as a USB memory. When a normal user connects the removable storage device 110 to a personal computer 130, the malicious code 121 stored in the removable storage device 110 is automatically run and a user system is infected with the malicious code.

Unlike an autoplay technique capable of easily setting deactivation through registry setting, the autorun technique makes it difficult for the normal user to set deactivation and therefore damage is spread. General security software such as a anti-virus program may not completely prevent infection by the malicious code using the autorun technique since it checks only well-known malicious codes on the basis of signatures.

### SUMMARY OF THE INVENTION

The present invention provides a device and method for blocking autorun of a malicious code that can prevent the malicious code from being spread using an autorun file stored in a removable storage device such as a USB memory.

According to an aspect of the present invention, there is provided a device for blocking autorun of a malicious code, including: a device manager that monitors a connection of a removable storage device, acquires a global unique identifier of the removable storage device, and deletes an autorun file for running the malicious code from the removable storage device; and a registry manager that determines whether a registry key for storing content of the autorun file is generated using the global unique identifier of the removable storage device and deletes the registry key.

According to another aspect of the present invention, there is provided a method for blocking autorun of a malicious code, including: monitoring whether a removable storage device is connected to a system; acquiring a global unique identifier of the removable storage device; determining whether a registry key for storing content of an autorun file for running the malicious code is generated using the global unique identifier of the removable storage device; deleting the registry key; and deleting the autorun file.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows a malicious code infection process using an autorun technique;

FIG. 2 is a block diagram showing a device for blocking autorun of a malicious code according to an exemplary embodiment of the present invention; and

FIG. 3 is a flowchart showing a method for blocking autorun of a malicious code according to an exemplary embodiment of the present invention.

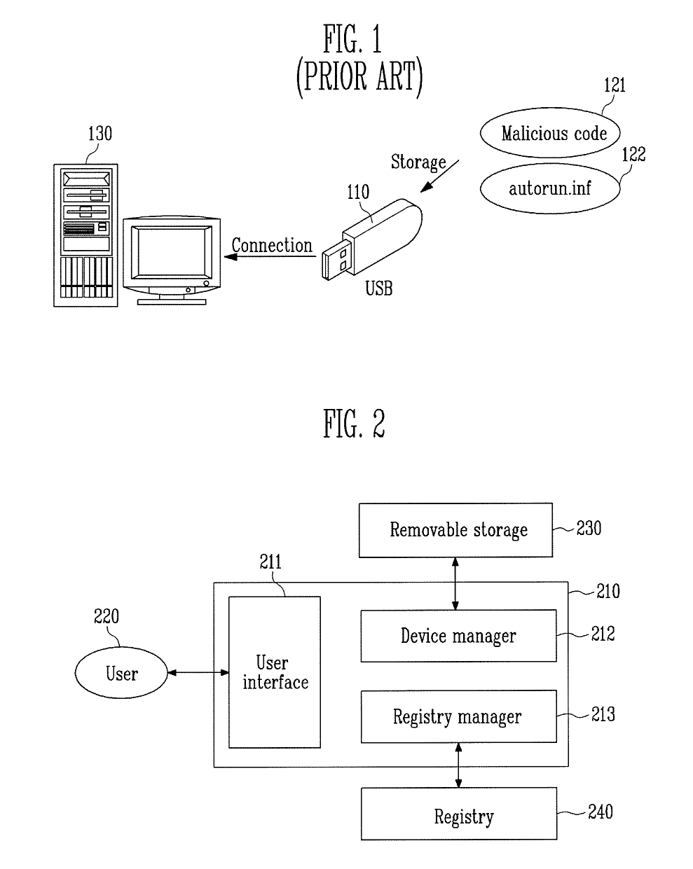

### DETAILED DESCRIPTION OF EXEMPLARY EMBODIMENTS

Exemplary embodiments of the present invention will be described in detail with reference to the accompanying drawings.

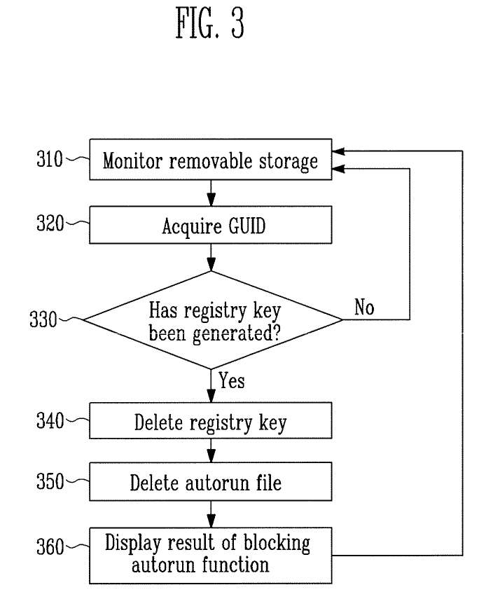

FIG. 2 is a block diagram showing a device for blocking autorun of a malicious code according to an exemplary embodiment of the present invention.

Referring to FIG. 2, a device 210 for blocking autorun of a malicious code according to an exemplary embodiment of the present invention includes a user interface 211, a device manager 212, and a registry manager 213. The user interface 211 receives a required command from a user 220 when the device 210 is in operation, and outputs a result of an event for blocking the autorun technique or deleting an autorun file (for example, autorun.inf) to the user 220. The device manager 212 monitors whether a removable storage device 230 is connected to a system, acquires a global unique identifier (GUID) of the connected removable storage device 230, deletes the autorun file from the removable storage device 230, and generates a folder having the same name as the autorun file. In an exemplary embodiment, the removable storage device may be a USB memory.

The registry manager 213 determines whether a specific registry key for storing a command and data in an autorun file has been generated in order to detect the autorun technique, and deletes the registry key to block execution of the autorun technique. In an exemplary embodiment, the registry manager 213 can determine whether the specific registry key has been generated by retrieving a registry 240 using a GUID of the removable storage.

FIG. 3 is a flowchart showing a method for blocking autorun of a malicious code according to an exemplary embodiment of the present invention.

Referring to FIG. 3, the device manager monitors whether the removable storage device is connected to the system (310) and acquires a GUID of the removable storage device when it is connected (320). Next, the registry manager determines whether a registry key for storing content of an autorun file has been generated using the acquired GUID (330), and returns to step 310 if the registry key has not been generated. For example, if connection of the removable storage device for storing an autorun.inf file is detected by the system using a Windows OS, a registry key having the name of a GUID of the removable storage device is generated in the registry of HKEY_CURRENT_USER\Software\Microsoft\Windows\Current Version\Explorer\MountPoints2, and content of the autorun.inf file is stored under the registry key. Accordingly, the registry manager can detect the autorun technique by retrieving the registry key whose name is the GUID of the removable storage device in the registry of a corresponding location.

When the registry key for storing the content of the autorun file is retrieved according to a determination result of step 330, the registry manager blocks the autorun technique by deleting the registry key (340). The device manager deletes the autorun file stored in the removable storage device (350). In an exemplary embodiment, the device manager generates a folder having the same name as the autorun file in the removable storage device simultaneously when the autorun file is deleted, thereby preventing the autorun file from being regenerated. For example, when the autorun file is autorun.inf, the device manager generates an autorun.inf folder after deleting the autorun.inf file, thereby preventing the autorun.inf file from being regenerated.

In another exemplary embodiment, the user interface can receive a user input verifying whether to delete the autorun file before it is deleted, and the device manager can delete the autorun file in response to input received from the user.

When a process for blocking the autorun technique is completed, the user interface can display a result of blocking the autorun technique to the user (360). In an exemplary embodiment, the user interface can display information indicating whether the autorun file or the registry key for storing the content of the autorun file was deleted to the user.

The present invention can block autorun of a malicious code stored in the removable storage device by retrieving and deleting a registry key for performing the autorun technique when a removable storage device is connected to a system.

And, the present invention can prevent an autorun file from being regenerated in the removable storage device by deleting the autorun file stored in the removable storage device and generating a folder having the same name as the autorun file.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A device for blocking autorun of a malicious code, comprising:
a device manager that monitors a connection of a removable storage device, acquires a global unique identifier of the removable storage device, and deletes an autorun file for running the malicious code from the removable storage device; and
a registry manager that determines whether a registry key for storing content of the autorun file is generated using the global unique identifier of the removable storage device and deletes the registry key.

2. The device of claim 1, further comprising:
a user interface that outputs a result of blocking the autorun technique to a user according to whether at least one of the autorun file and the registry key has been deleted.

3. The device of claim 2, wherein the user interface receives a command from the user whether to delete the autorun file; and
the device manager deletes the autorun file in response to the command of the user.

4. The device of claim 1, wherein the device manager generates a folder having the same name as the autorun file in the removable storage.

5. The device of claim 1, wherein the autorun file is an autorun.inf file.

6. The device of claim 5, wherein the registry key is generated in a registry of HKEY_CURRENT_USER\Software\Microsoft\Windows\Current Version\Explorer\MountPoints2 of a Windows operating system.

7. The device of claim 6, wherein a name of the registry key is the global unique identifier of the removable storage.

8. A method for blocking autorun of a malicious code, comprising:
monitoring whether a removable storage device is connected to a system;
acquiring a global unique identifier of the removable storage device;
determining whether a registry key for storing content of an autorun file for running the malicious code is generated using the global unique identifier of the removable storage device;
deleting the registry key; and
deleting the autorun file.

9. The method of claim 8, further comprising:
outputting a result of blocking the autorun technique.

10. The method of claim 8, further comprising:
receiving a command from the user whether to delete the autorun file,
wherein the autorun file is deleted in response to the command of the user.

11. The method of claim 8, further comprising:
generating a folder having the same name as the autorun file in the removable storage device.

12. The method of claim 8, wherein the autorun file is an autorun.inf file.

13. The method of claim 12, wherein the registry key is generated in a registry of HKEY_CURRENT_USER\Software\Microsoft\Windows\Current Version\Explorer\MountPoints2 of a Windows operating system.

14. The method of claim 13, wherein a name of the registry key is the global unique identifier of the removable storage.
